(19) United States
(12) Patent Application Publication
(10) Pub. No.: US 2017/0214857 A1
(43) Pub. Date: Jul. 27, 2017

(54) MOBILE TERMINAL AND METHOD FOR CONTROLLING THE SAME

(71) Applicant: LG ELECTRONICS INC., Seoul (KR)

(72) Inventors: Wonjoo PARK, Seoul (KR); Youngjun KIM, Seoul (KR); Eunjeong RYU, Seoul (KR)

(21) Appl. No.: 15/400,237

(22) Filed: Jan. 6, 2017

(30) Foreign Application Priority Data
Jan. 27, 2016 (KR) 10-2016-0010138

(51) Int. Cl. H04N 5/232; H04N 5/225

(52) U.S. Cl. CPC H04N 5/23293; H04N 5/23216; H04N 5/2257; G06F 3/0482

(57) ABSTRACT

Disclosed is a mobile terminal and a method for controlling the mobile terminal. A mobile terminal and a method for controlling the mobile terminal according to the present disclosure may display a preview on a display unit upon activating a camera, and perform at least one automatic capture for the preview, when the preview meets a predetermined condition based on a specific manual captured image stored in a memory. According to the present disclosure, a convenience in using the terminal is improved by capturing automatically a screen captured through a camera, when an automatic capturing condition is met by the mobile terminal despite that no input for capturing is selected by a user.

### CROSS-REFERENCE TO RELATED APPLICATIONS

This application claims priority to Korean Patent Application No. 10-2016-0010138 filed on 27 Jan. 2016 in Korea, the entire contents of which is hereby incorporated by reference in its entirety.

### BACKGROUND OF THE DISCLOSURE

1. Field of the Disclosure

The present disclosure relates to a mobile terminal equipped with a camera capable of capturing a picture or an image and a controlling method for the mobile terminal.

2. Background of the Disclosure

Terminals may be generally classified as mobile/portable terminals or stationary terminals according to their mobility. Mobile terminals may also be classified as handheld terminals or vehicle mounted terminals according to whether or not a user may directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

Recently, a function of a digital camera is incorporated into a mobile terminal as a performance of a camera embedded in a mobile terminal is improved. Further, a research is being spotlighted for a method of capturing an image using a mobile terminal and a method for managing the captured image such as editing thereof, etc.

### SUMMARY OF THE DISCLOSURE

Accordingly, an object of the present invention is to address the above-noted and other problems. Another object is to provide a mobile terminal capable of displaying a preview on a display unit upon activating a camera, and performing at least one automatic capture for the preview, when the preview meets a predetermined condition based on a specific manual captured image stored in a memory. Further, the present disclosure provides a method for controlling the mobile terminal.

According to one aspect of the invention, for achieving the above or another object, there is provided a mobile terminal comprising a memory, a camera, a display unit, and the controller configured to display a preview on the display unit upon activating the camera, and perform at least one automatic capture for the preview, when the preview meets a predetermined condition based on a specific manual captured image stored in the memory.

Further, according to another aspect of the present disclosure, provided is a method for controlling a mobile terminal, the method comprising: displaying a preview on a display unit upon activating a camera; determining whether the preview meets a predetermined condition based on a specific manual captured image stored in a memory; and performing at least one automatic capture for the preview, when the preview meets the predetermined condition.

The mobile terminal and the method for controlling the mobile terminal according to the present disclosure have following effects:

According to at least one of embodiments of the present disclosure, the terminal is capable of capturing automatically and providing an image in compliance with the user's desires by automatically determining the user's preferences based on the manual captured image.

Further, according to at least one of embodiments of the present disclosure, the terminal is capable of capturing immediately a momentary event that is easily missed by capturing automatically an image for the event based on the user's preferences.

Further scope of applicability of the present invention will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure.

FIGS. 1B and 1C are conceptual views of one example of the mobile terminal, viewed from different directions;

FIG. 2 is a flowchart for explaining a method for controlling a mobile terminal in accordance with the present disclosure.

FIGS. 3 to 18 are diagrams for explaining a method for controlling a mobile terminal in accordance with the present disclosure.

### DETAILED DESCRIPTION OF THE PREFERRED EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

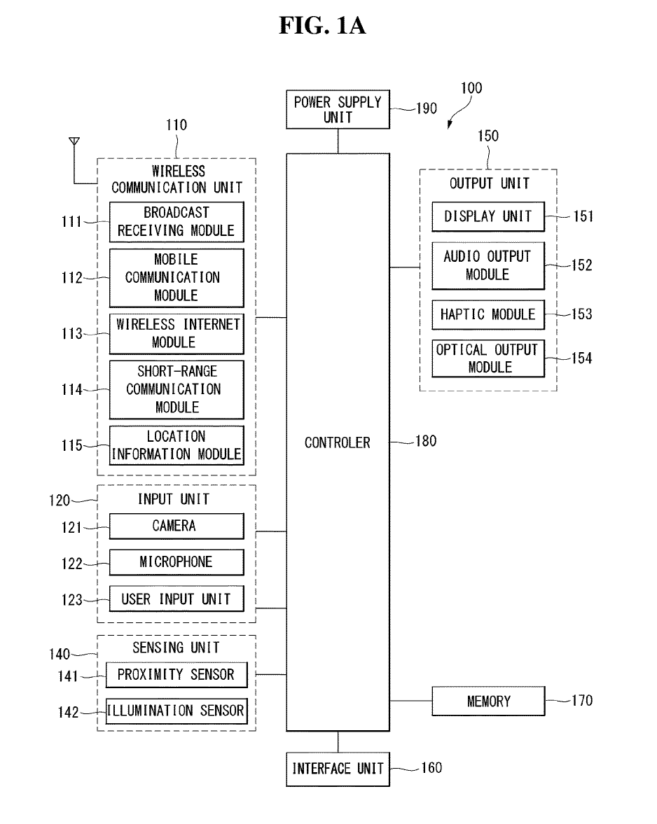

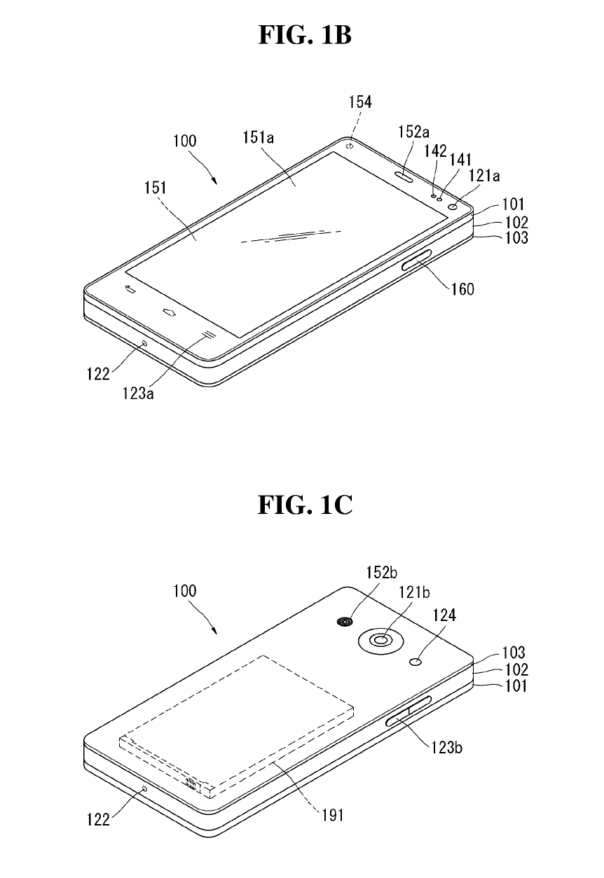

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, the controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that may be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may be configured to be configured to be configured to provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 may be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 may transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideB and (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user may check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. when desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal may be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames may be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input may be processed in various manners according to a function being executed in the mobile terminal 100. when desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 may sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 may control the mobile terminal 100 to execute different operations or process different data according to whether a touch with respect to a point on the touch screen is either a proximity touch or a contact touch.

A touch sensor may sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may be configured to be configured to be configured to sense which region of the display unit 151 has been touched. Here, the touch controller may be a component separate from the controller 180, the controller 180, and combinations thereof.

In some embodiments, the controller 180 may be configured to be configured to be configured to execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 may provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 may be configured to generate various tactile effects that a user feels, perceive, or otherwise experience. A typical example of a tactile effect generated by the haptic module 153 is vibration. The strength, pattern and the like of the vibration generated by the haptic module 153 may be controlled by user selection or setting by the controller. For example, the haptic module 153 may output different vibrations in a combining manner or a sequential manner.

Besides vibration, the haptic module 153 may generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that may absorb or generate heat, and the like.

The haptic module 153 may also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 may output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 may receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device may be connected with the terminal 100 via the interface unit 160.

When the mobile terminal 100 is connected with an external cradle, the interface unit 160 may serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 may store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may be configured to be configured to be configured to typically control the general operations of the mobile terminal 100. For example, the controller 180 may be configured to be configured to be configured to set or release a lock state for restricting a user from inputting a control command with respect to applications when a status of the mobile terminal meets a preset condition.

The controller 180 may also perform the controlling and processing associated with voice calls, data communications, video calls, and the like, or perform pattern recognition processing to recognize a handwriting input or a picture drawing input performed on the touch screen as characters or images, respectively. In addition, the controller 180 may control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 may receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which may implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which may be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 may be configured to output light for indicating an event generation. Examples of such events include a message reception, a call signal reception, a missed call, an alarm, a schedule notice, an email reception, information reception through an application, and the like. When a user has checked a generated event, the controller may control the optical output unit 154 to stop the light output.

The first camera 121a may process image frames such as still or moving images obtained by the image sensor in a capture mode or a video call mode. The processed image frames may then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit may be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof. The rear input unit may be located to overlap the display unit 151 of the front side in a thickness direction of the terminal body. As one example, the rear input unit may be located on an upper end portion of the rear side of the terminal body such that a user may easily manipulate it using a forefinger when the user grabs the terminal body with one hand. Alternatively, the rear input unit may be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 may have a larger screen.

As a further alternative, the mobile terminal 100 may include a finger scan sensor which scans a user's fingerprint. The controller 180 may then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. when desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. when desired, second camera 121a may alternatively be located at other locations, or made to be moveable, in order to have a different image capturing direction from that which is shown.

The second camera 121b may include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b may be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 may be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 may also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The location information module 115 is generally configured to detect, calculate, or otherwise identify a position of the mobile terminal. As an example, the location information module 115 may include a Global Position System (GPS) module, a Wi-Fi module, or both. when desired, the location information module 115 may alternatively or additionally function with any of the other modules of the wireless communication unit 110 to obtain data related to the position of the mobile terminal.

A typical GPS module 115 may measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites.

Furthermore, the GPS module may acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server. The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information may be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal. Such extracted location information may be transmitted to the mobile terminal 100 through the Wi-Fi location determination server, thereby acquiring location information of the mobile terminal 100.

The mobile terminal 100 may acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™ Radio Frequency Identification (RFID), Infrared Data Association (IrDA), Ultra Wideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, when a mobile terminal having card information on a payment card (e. g, a credit card or a bus card) approaches a card reader, a short-range mobile payment may be executed. As another example, when a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal may read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. when the data received from the external tag is a smart poster type, the controller may execute a browser (e.g., Internet browser). when the data received from the external tag is a text type, the controller may execute a text viewer. when the data received from the external tag is a URI type, the controller may execute a browser or originate a call. when the data received from the external tag is a general control type, the controller may execute a proper operation according to control content.

In some cases in which the NFC module operates in a P2P (Peer-to-Peer) mode, the mobile terminal may execute P2P communication with another mobile terminal. In this case, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode may be effectively utilized in switching data of a small capacity, because an available distance for NFC communication is relatively short. Further preferred embodiments will be described in more detail with reference to additional drawing figures. It is understood by those skilled in the art that the present features may be embodied in several forms without departing from the characteristics thereof.

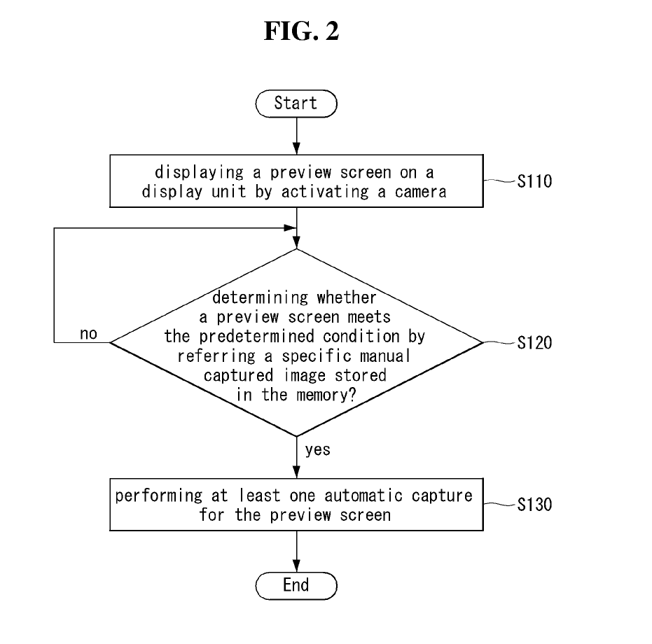

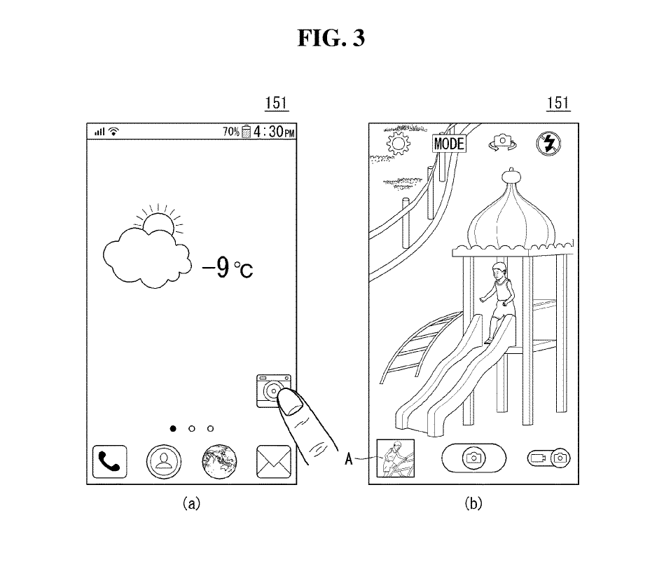

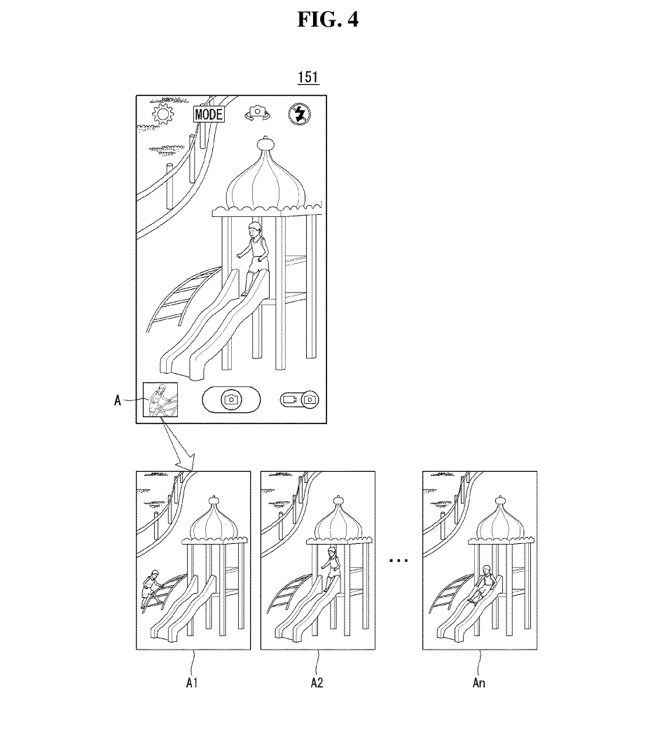

FIG. 2 is a flowchart for explaining a method for controlling a mobile terminal in accordance with the present disclosure, and FIG. 3 to FIG. 18 are diagrams for explaining a method controlling a mobile terminal in accordance with the present disclosure.

Referring to FIG. 2, the controller 180 of the mobile terminal may be configured to display a preview on the display unit 151 upon activating a camera 121 (S110), and determine whether a preview meets a predetermined condition based on a specific manual captured image stored in a memory 170 (S120).

Hereinafter, a requirement that an automatic capturing condition is met may correspond to a requirement that the preview meets the predetermined condition based on the specific manual captured image.

The controller 180 of the mobile terminal may be configured to perform at least one automatic capture for the preview, when the preview meets the predetermined condition (yes) (S140). To the contrary, the controller 180 may be configured to continuously display the preview without performing an automatic capture, when the preview does not meet the predetermined condition (no) (S120).

Specifically, the controller 180 may be configured to capture automatically and store an image obtained through the camera 121, when the automatic capturing condition is met while the camera 121 is being activated. The controller 180 may be configured to display the preview on the display unit 151 upon the activation of the camera 121, and, then, perform an automatic image capturing, and display the automatic captured image on the preview image. Further, the controller 180 may be configured to capture automatically a screen obtained through a camera 121 when an automatic capturing condition is met, though a camera 180 is activated but a display unit 151 is turned off.

The controller 180 may determine as meeting an automatic capturing condition when at least one condition is met for a case that an object of the specific manual captured image is included on a screen obtained through the camera 121 or the preview, or for a case that a capturing condition of the screen obtained through the camera 121 or the preview is the same as a capturing condition of the specific manual captured image. For example, the controller 180 may extract an object included in a specific manual capturing image, and may perform an automatic capture, when an extracted object is included in a screen obtained through a camera 121 or a preview. In this case, the controller 180 may perform an automatic capture only when an extracted object as a movement of a camera 121 is obtained through a camera 121. Further, the controller 180 may perform an automatic capture when a screen that at least one of a capturing condition is the same for a specific manual captured image condition such as a white balance, a degree to an exposure, ISO sensitivity, whether an auto focus is predetermined, a flash mode, and location information etc. is obtained through a camera 121.

The controller 180 may determine a specific manual captured image as the latest manual captured image or a manual captured image within a predetermined time interval of a plurality of manual captured image stored in a gallery application. In addition to that, the controller 180 may determine a specific manual captured image with a variety of method.

The controller 180 may capture automatically a screen obtained through a camera 121 or a preview greater than or equal to once, when an automatic capture condition is met. In this case, the controller 180 may predetermine an automatic capture timing, and the number of times for an automatic capture etc.

The controller 180 may generate a link between at least one automatic captured image and a specific manual captured image, and may display an indicator indicating the link on the at least one automatic captured image or the specific manual captured image.

The controller 180 may generate a link between the at least one automatic captured image and the specific manual captured image, and display the at least one automatic captured image overlapped with the specific manual captured image when the specific manual captured image is displayed.

The controller 180 may to turn off a display unit 151 while a camera 121 is being activated, when a movement of a terminal is beyond a predetermined range or an aiming direction of the terminal is beyond a predetermined range. The controller 180 may display a captured object obtained through the activated camera 121 by turning on the display unit 151 as a preview on the display unit 151, when the movement of the terminal and the aiming direction of the terminal is changed to be included in a predetermined range. Further, the controller 180 may capture automatically the captured object obtained through the activated camera 121 prior to displaying the preview when the movement of the terminal and the aiming direction of the terminal is changed to be included in a predetermined range.

The controller 180 may display a user interface capable of selecting a store or a delete for the at least one automatic captured image. In detail, the controller 180 may display at least one automatic captured image on a preview or a specific manual captured image, and display a menu item that deletes or stores the automatic captured image when a specific input for the automatic captured image is received. The controller 180 may delete or store each of automatic captured image by dragging the automatic captured image to a delete or a store menu item.

The controller 180 may store at least one automatic captured image in a gallery item on a memory. In this case, the controller 180 may store an automatic captured image in a folder different from a manual captured image.

The controller 180 may generate at least one automatic captured image corresponding to the same location information or a plurality of automatic captured image that is stored in the same folder as a story album, when a story album for at least one image stored in a gallery item is generated.

The controller 180 may display a specific manual captured image linked with the automatic captured image overlapped with the automatic captured image, when a specific automatic captured image of the automatic captured image is displayed on the display unit 151. The controller 180 may display a determination condition for capturing of the automatic captured image on the automatic captured image, when a specific automatic captured image of the automatic captured image is displayed on the display unit 151. Here, the determination condition for capturing of the automatic captured image may include a capturing condition of the preview including at least one of case whether an object is the same each other, or case that a predetermined auto focus, a predetermined white balance, a predetermined exposure, a predetermined suspension time of the preview, or a predetermined face of a human is included.

The controller 180 may perform capturing a moving picture for the preview, when the specific manual captured image captured continuously is existed on a memory 170 and the preview meets a predetermined condition. In this case, the controller 180 may display an indication on a display unit 151 indicating that a moving picture is being captured.

The controller 180 may perform an automatic capture, when at least one condition is further met for a case that a specific event is included in the preview, a movement of the terminal is a predetermined specific motion, a predetermined gesture input is received on the preview, an alarm for recommending an automatic capture is selected, or a specific event is received at a terminal. In detail, the controller 180 may perform an automatic capture, when at least one condition is met that a viewing sight of a captured object included in a preview is projected to a camera 121, a movement of a terminal is rotated along a horizontal direction of 360 degree, a drag input with two fingers is received on a preview, an alarm of recommending an automatic capture is selected in specific location information, or an amount of an impact greater than or equal to a reference value is sensed on a terminal

Herein below, referring to FIGS. 3 to 18, specific embodiments of a method of controlling a mobile terminal according to the present disclosure is explained. FIG. 3 is a diagram for explaining a method of executing a camera application in a mobile terminal according to an embodiment of the present disclosure.

Referring to FIG. 3, the controller 180 of a mobile terminal may display a preview on a display unit 151 by operating a camera 121, when a touch input for an icon indicating a camera application is received.

In detail, the controller 180 may operate firstly a camera 12, and may display a screen obtained through the operated camera 121 on a display unit 151 in a preview, when a camera application is executed. In this case, a specific interval may be occurred between a timing of operating a camera 121 and timing that a preview is displayed.

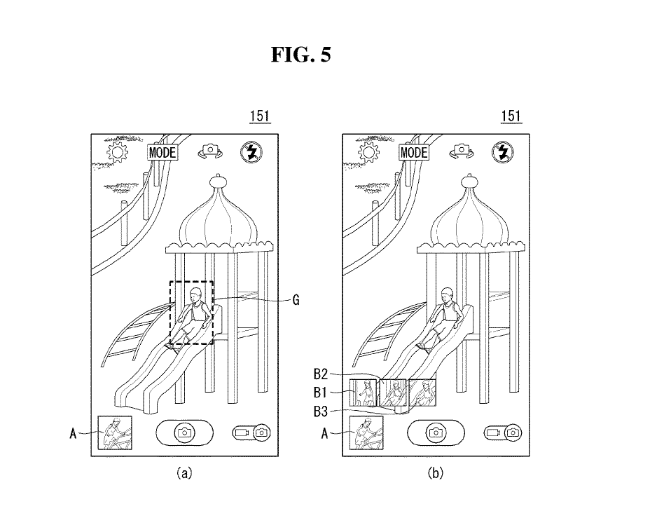

The controller 180 may operate a camera 121 by executing a camera application, and then may store a captured image in a gallery application. A camera application and a gallery application is interoperated each other, and a shortcut menu may be provided that may convert an execution screen of a camera application into a gallery application. On the other hand, a shortcut menu may be provided that may convert an execution screen of a gallery application into a camera application. FIG. 4 is a diagram for explaining a method of determining a specific manual capturing image in a mobile terminal according to an embodiment of the present disclosure.

Referring to FIG. 4, the controller 180 of a mobile terminal may display a shortcut menu (A) of a gallery application on an execution screen of a camera application, and may determine a specific manual captured image, and may display it as the shortcut menu (A).

In detail, the controller 180 may determine that latest captured, and manual captured image that is stored in a gallery application as a specific manual captured image, or manual captured images (A1 to AN) within a predetermined time interval from a present time as a specific manual captured image. The controller 180 may display at least one specific manual captured image on a preview.

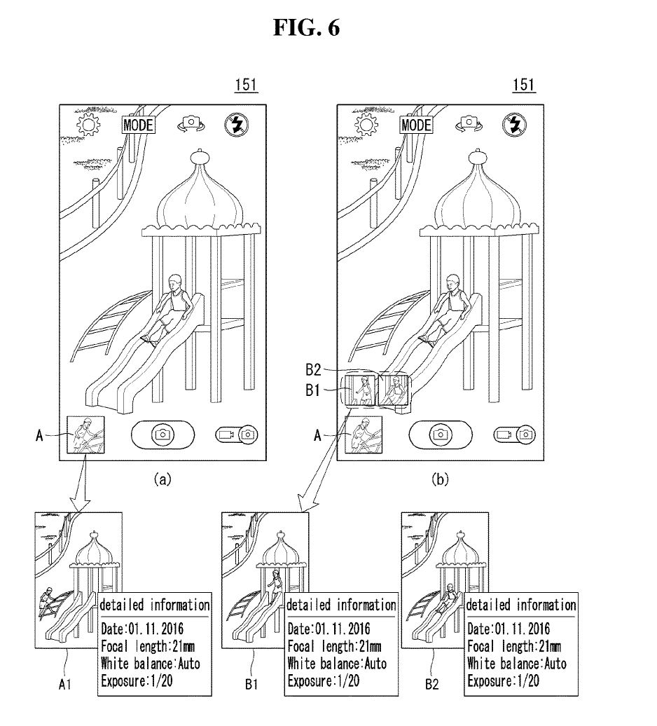

FIGS. 5 and 6 is a diagram for explaining a condition of performing an automatic capture and a method of displaying an automatic captured image in a mobile terminal according to an embodiment of the present disclosure.

Referring to FIGS. 5 and 6, the controller 180 of a mobile terminal may perform an automatic capture for a preview, when a condition for capturing automatically is met, and may display an automatic captured image (B1, B2, B3) on a preview.

In detail, the controller 180 may determine that a condition for capturing automatically is met, when an object included in a specific manual captured image (A) in included in a preview. The controller 180 may display a guide (G) in a region that an object corresponding to a preview is displayed.

The controller 180 may repeat a condition for capturing automatically, when a condition for capturing automatically is met and a change is occurred beyond a range that a preview is predetermined. That is, the controller 180 may obtain a plurality of image (B1, B2, B3). For example, an automatic capture may be performed whenever a location or a motion of a young child displayed on a preview is changed as young child moves, when a young child and a playground is included in a preview (FIG. 5).

The controller 180 may determine that a condition for capturing automatically is met, when a capturing condition of a specific manual captured image (A) is the same as a capturing condition of a preview. The controller 180 may display a capturing condition overlapped on a specific manual captured image (A) or a preview, when a condition for capturing automatically is determined based on a capturing condition of a specific manual captured image (A).

The controller 180 may capture automatically a preview of the same capturing condition with a capturing condition of a specific manual captured image (A), and then may display an automatic captured image (B1, B2) on a preview. In this case, a capturing condition overlapped on an automatic captured image (B1, B2) may be displayed (FIG. 6).

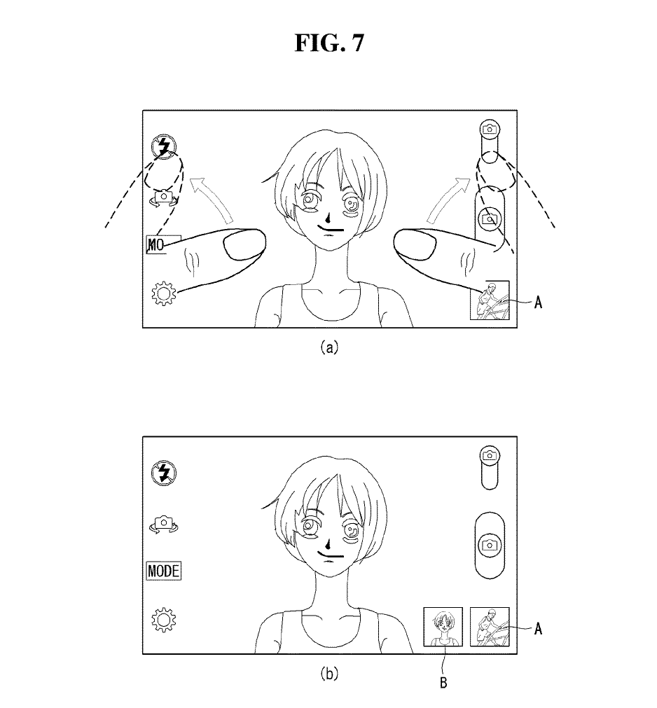

FIGS. 7 to 9 are diagrams for explaining a condition of performing an automatic capture in a mobile terminal according to an embodiment of the present disclosure.

Referring to FIGS. 7 to 9, the controller 180 of a mobile terminal may perform an automatic capture, when at least one condition is further met for a case that a specific event is included in the preview, a movement of the terminal is a predetermined specific motion, a predetermined gesture input is received on the preview, an alarm for recommending an automatic capture is selected, or a specific event is received at a terminal.

The controller 180 may perform an automatic capture, when a predetermined gesture input is received on a preview. For example, the controller 180 may determine whether the above explained condition for capturing automatically is met and may perform an automatic capture, when a drag input with two fingers is received on a preview (FIG. 7).

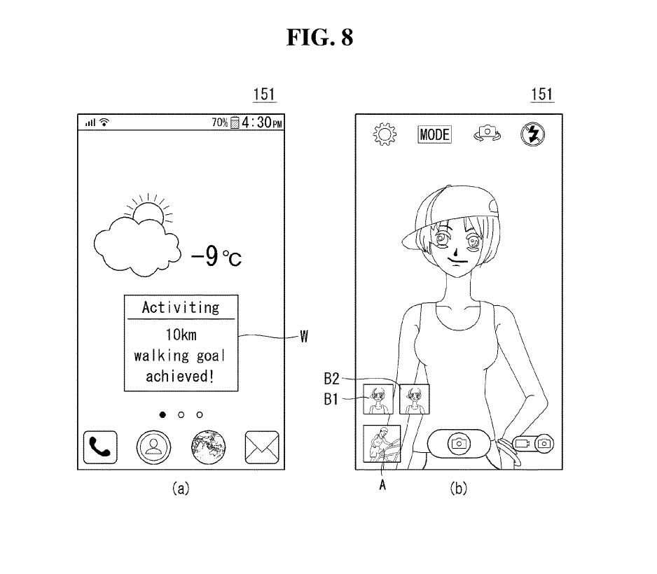

The controller 180 may perform an automatic capture, when a specific event is received by a terminal while a camera 121 is being activated. For example, the controller 180 may perform an automatic capture when a specific event that a predetermined goal is achieved for an excises application installed in a terminal, a phone call is received, or a message is received etc. is received. In this case, the controller 180 may display an alarm that a specific event is received on a pop-up window (W), and then may a screen obtained through an activated camera 121 on a display unit 151 in a preview. Further, the controller 180 may display an automatic captured image (B1, B2) on a preview together, when a screen obtained through a camera 121 is captured automatically prior to displaying a preview (FIG. 8).

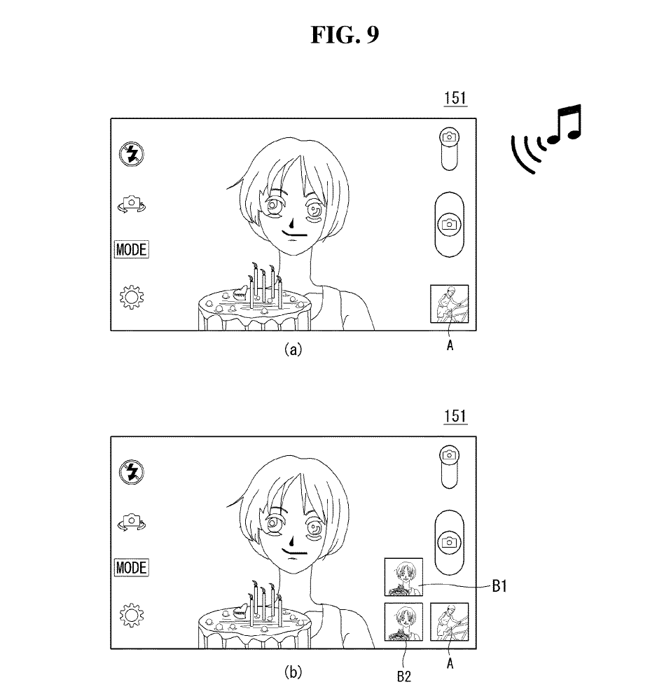

The controller 180 may perform an automatic capture, when a specific sound is received by a terminal while a preview is being displayed. For example, the controller 180 may perform an automatic capture, when a specific sound is received through a microphone installed in a terminal. Here, a specific sound may be a sound comprising a predetermined keyword, or a sound of a specific frequency. The controller 180 may capture automatically a preview, and may display an automatic captured image (B1, B2) overlapped on a preview, when a specific sound is received (FIG. 9).

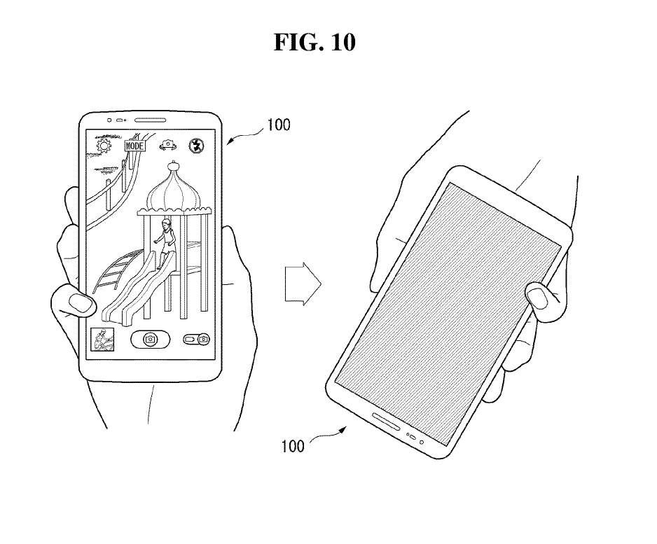

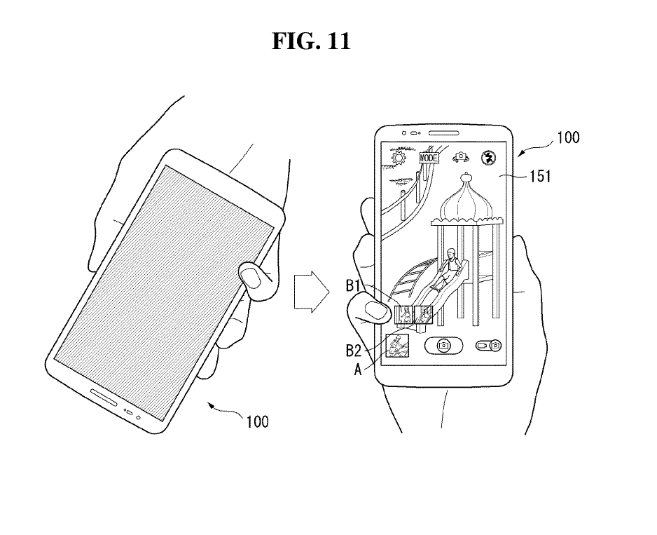

FIGS. 10 and 11 are diagrams for explaining a method of turning on or off a display unit according to a movement of a terminal in a mobile terminal according to an embodiment of the present disclosure.

The controller 180 may turn off a display unit 151 while the camera is being activated, for at least one of case that a movement of a terminal is beyond a predetermined range or an aiming direction of the terminal is beyond a predetermined range (FIG. 10).

The controller 180 may display a captured object obtained through an activated camera by turning on again a display unit 151 in a preview on a display unit 151, when the movement of a terminal and the aiming direction of the terminal is changed to be include in a predetermined range while a camera is activated. The controller 180 may capture automatically a captured object obtained through an activated camera prior to displaying the preview and may display an automatic captured image (B1, B2) on a preview together, when the movement of a terminal and the aiming direction of the terminal is changed to be included in a predetermined range (FIG. 11).

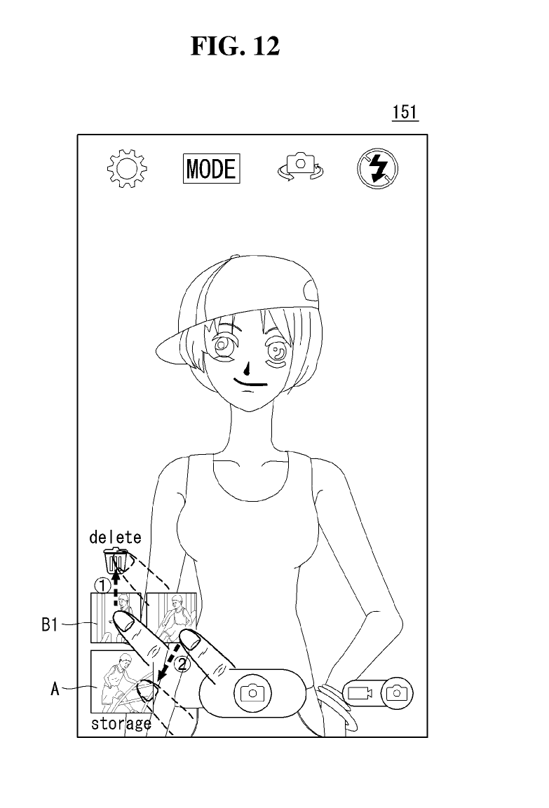

FIG. 12 is diagrams for explaining a method of managing an automatic captured image on a preview in a mobile terminal according to an embodiment of the present disclosure.

Referring to FIG. 12, the controller 180 of a mobile terminal may display an automatic captured image (B1, B2) on a preview, when an automatic capture is performed, and may display an image management menu, when a specific input for an automatic captured image (B1, B2) is received.

In detail, the controller 180 may display a menu item for deleting or saving on a preview, when a specific input for one of an automatic captured image (B1, B2) is received. Here, a specific input may be a long touch input.

The controller 180 may delete a first automatic captured image (B1) through an input of dragging a first automatic captured image (B1) to a delete menu item, and may store a second automatic captured image (B2) in a gallery application through an input of dragging a second automatic captured image (B2) to a store menu item. In this case, the controller 180 may store a second automatic captured image (B2) in a folder different from a folder that a manual captured image is stored.

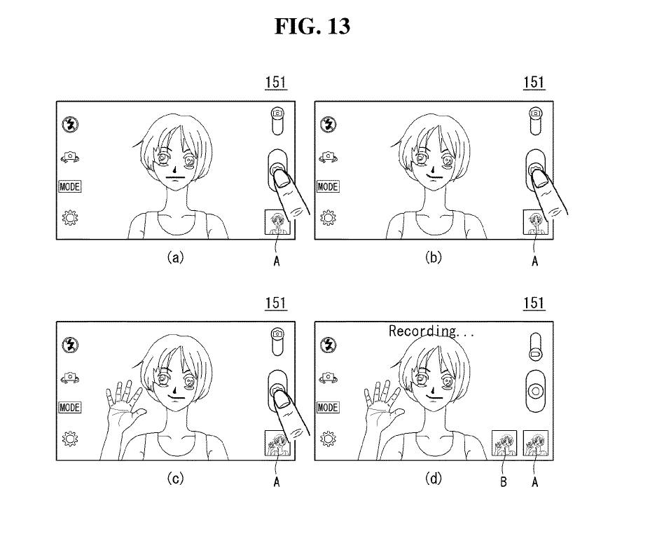

FIG. 13 is a diagram for explaining a method of performing an automatic capture of a preview when a manual captured image captured continuously in a mobile terminal according to an embodiment of the present disclosure is determined as a specific image.

Referring to FIG. 13, the controller 180 of a mobile terminal may perform an automated capture of a preview in capturing a moving picture, when a manual captured image that a preview is captured continuously greater than or equal to two times is determined as a specific manual captured image.

The controller 180 may indicate an indicator (e.g., a word of recording etc.) indicating that a moving picture is captured on a preview, when an automatic capture is performed by capturing a moving picture.

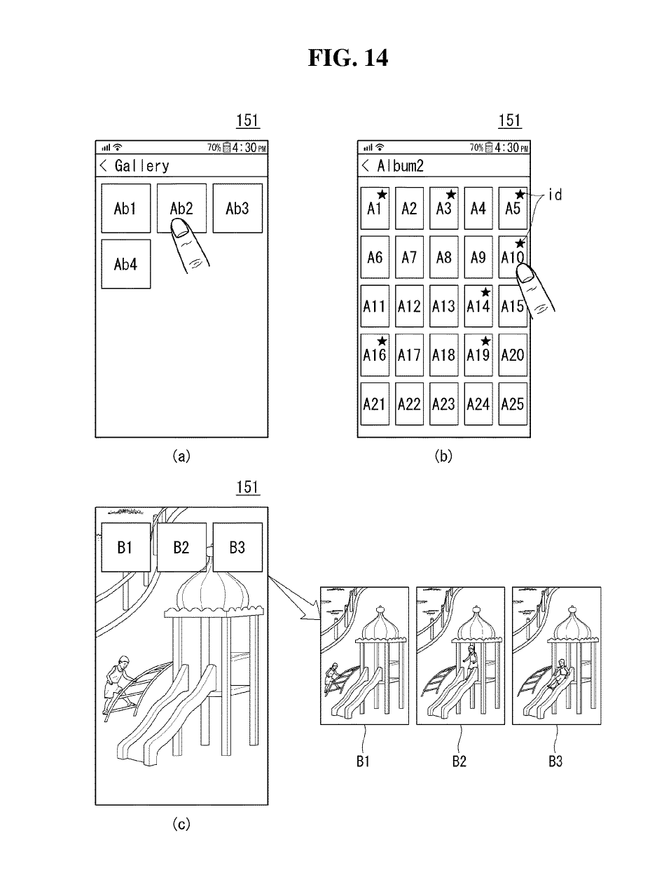

FIGS. 14 to 18 are diagrams for explaining a method of managing a manual captured image in a gallery application of a mobile terminal according to an embodiment of the present disclosure is determined as a specific image.

Referring to FIG. 14, the controller 180 of a mobile terminal may display a folder for saving a manual captured image and a folder for saving an automatic captured image distinctively on an execution screen of a gallery application

The controller 180 may display a plurality of manual captured image (A1 to A20) captured manually on a display unit 151, when a folder for saving a manual captured image (Ab2) is selected. The controller 180 may display a specific indicator (id) on a manual captured image (A1, A3, A5, A10, A14, A16, A19) linked with an automatic captured image of a plurality of manual captured image (A1 to A20) captured manually.

The controller 180 may display a tenth manual captured image (A10) as a whole screen of a display unit 151, and may display an automatic captured image (B1, B2, B3) linked with a tenth manual captured image (A10), when a selective input is received for a tenth manual captured image (A10) that a specific indicator is displayed.

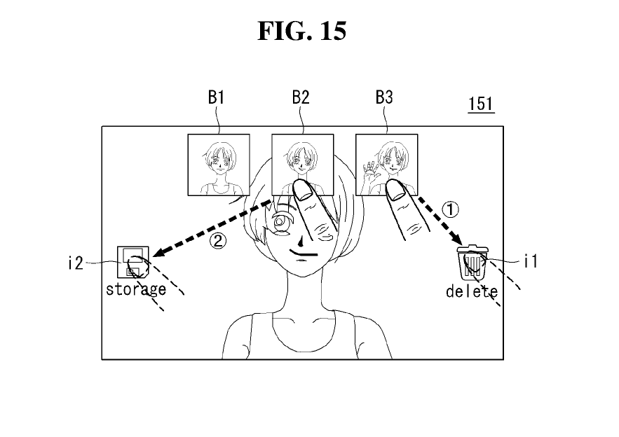

Referring to FIG. 15, the controller 180 of a mobile terminal may perform an edit for an automatic captured image while a specific manual captured image and a linked automatic captured image (B1, B2, B3) is being displayed on a display unit 151. The controller 180 may display a menu item for deleting or saving, when a specific input is received for a first to third automatic captured image (B1, B2, B3), while a specific manual captured image and a linked first to third manual captured image (B1, B2, B3) is being displayed overlapped on a display unit 151.

The controller 180 may store a second automatic captured image (B2) by dragging a second automatic captured image (B2) to a store menu item (i2), and may delete a third automatic captured image (B3) by dragging a third automatic captured image (B3) to a delete menu item (i1).

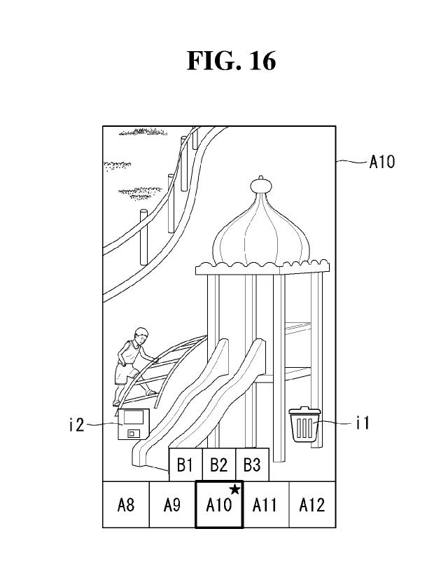

Referring to FIG. 16, the controller 180 of a mobile terminal may display another manual captured image comprising a specific manual captured image on a second region, and may display an automatic captured image (B1, B2, B3) linked on a first region, when a specific manual captured image (A10) is displayed on a first region of a whole screen of a display unit 151.

The controller 180 may further display a menu item (i1, i2) that an automated captured image (B1, B2, B3) may be editable on a display unit 151, when a specific manual captured image (A10) and a linked automatic captured image (B1, B2, B3) is displayed overlapped.

According to the present disclosure, a linked automatic captured image may be edited, by displaying a linked automatic captured image is displayed overlapped on a specific manual captured image, when a linked automatic captured image is existed on a displaying screen of a specific manual captured image.

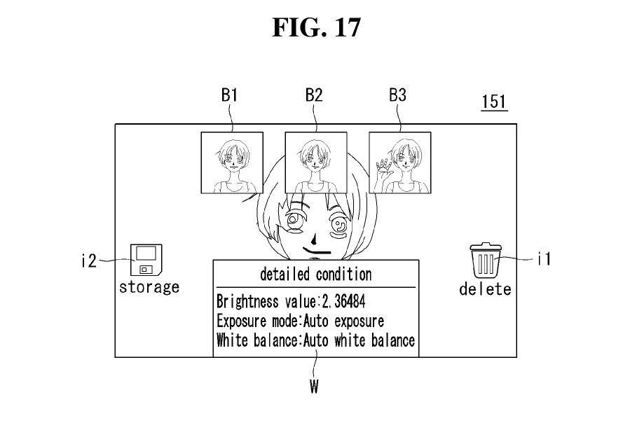

Referring to FIG. 17, the controller 180 of a mobile terminal may further display a capturing condition (W) of a preview that is a condition of an automatic capture on a display unit 151, when a specific manual captured image and a linked automatic captured image (B1, B2, B3) is displayed.

In detail, the controller 180 may display a condition for capturing automatically an automatic captured image (B1, B2, B3) together based on a specific manual captured image. For example, the controller 180 may display a capturing condition of a specific manual captured image and an automatic captured image such as ‘a bright: 00’, ‘a degree to an exposure:’, ‘a white balance: □□’ together with a specific manual captured image and an automatic captured image on a display unit 151. Further, the controller 180 may also display them together with a menu item (i1, i2) for editing an automatic captured image (B1, B2, B3).

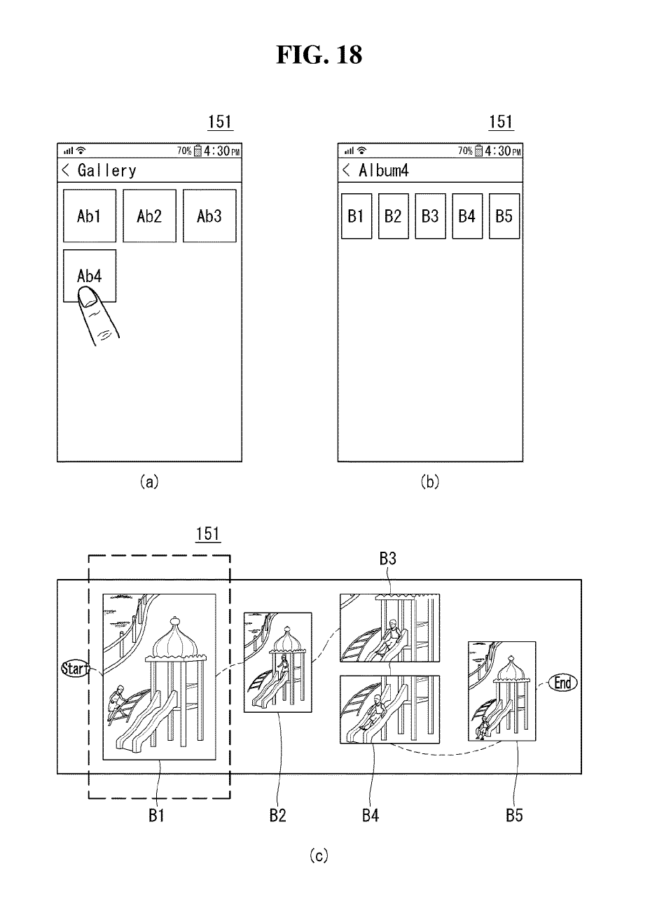

Referring to FIG. 18, the controller 180 of a mobile terminal may display an automatic captured image (B1 to B5) on a display unit 151, when a folder (Ab4) that an automatic captured image is stored is selected in a gallery application.

The controller 180 may generate an automatic captured image (B1 to B5) that is stored in Album 4 as a story album, when an input is received for generating a folder (Ab4) that an automatic captured image is stored as a story album.

In detail, the controller 180 may generate a story album by connecting sequentially an automatic captured image (B1 to B5) that is stored in Album 4 according to an order of a time or an order of moving place.

According to the present disclosure, it may improve a convenience in using, by capturing automatically a screen captured through a camera, when a condition for capturing automatically is met by a mobile terminal, despite that no input for capturing is selected by a user.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. when desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. The present teachings may be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A mobile terminal comprising:
a memory;
a camera;
a display unit; and
a controller that controls the mobile terminal to:
display a preview on the display unit when the camera is activated, and perform at least one automatic image capture for the displayed preview, when the preview meets a predetermined condition based on a specific manually captured image stored in the memory.

2. The mobile terminal of claim 1,
wherein the controller determines that the preview has met the predetermined condition when at least one of an object of the specific manually captured image is included on a screen obtained through the camera or the preview, or a capturing condition of the screen obtained through the camera or the preview is the same as a capturing condition of the specific manually captured image.

3. The mobile terminal of claim 1,
wherein the controller selects (i) a captured image within a predetermined time interval from a present time or (ii) a manually captured image captured prior to displaying the preview, as the specific manually captured image.

4. The mobile terminal of claim 1,
wherein the controller generates a link between the at least one automatically captured image and the specific manually captured image, and displays an indicator indicating the link on the at least one automatically captured image or the specific manually captured image.

5. The mobile terminal of claim 1,
wherein the controller generates a link between the at least one automatically captured image and the specific manually captured image, and displays the at least one automatically captured image overlapped with the specific manually captured image when the specific manually captured image is displayed.

6. The mobile terminal of claim 1,
wherein, when a movement of the mobile terminal is beyond a predetermined range or an aiming direction of the mobile terminal is beyond a predetermined range, the controller turns off the display unit while the camera is activated.

7. The mobile terminal of claim 6,
wherein, when the movement of the mobile terminal and the aiming direction of the mobile terminal are changed to be included in predetermined ranges, respectively, the controller displays a captured object obtained through the activated camera as a preview by turning on the display unit.

8. The mobile terminal of claim 7,
wherein the controller captures automatically the captured object obtained through the activated camera prior to displaying the preview.

9. The mobile terminal of claim 1,
wherein the controller displays a user interface facilitating the selection of storage or deletion for the at least one automatically captured image.

10. The mobile terminal of claim 1,
wherein the controller stores the at least one automatically captured image as a gallery item in the memory, and generates, when a story album for at least one image stored in the gallery item is generated, the at least one automatically captured image corresponding to the same location information as the story album.

11. The mobile terminal of claim 1,
wherein the controller stores an automatically captured image in a folder different from a manually captured image.

12. The mobile terminal of claim 11,
wherein, when a specific automatically captured image of the automatically captured image is displayed on the display unit, the controller displays the specific manually captured image linked with the automatically captured image overlapped with the automatically captured image.

13. The mobile terminal of claim 11,
wherein, when a specific automatically captured image of the automatically captured image is displayed on the display unit, the controller displays a determination condition for capturing of the automatically captured image on the automatically captured image.

14. The mobile terminal of claim 13,
wherein the determination condition for capturing of the automatically captured image comprises at least one of whether an object is the same, a predetermined auto focus, a predetermined white balance, a predetermined exposure, a predetermined suspension time of the preview, or a predetermined face of a human is included.

15. The mobile terminal of claim 1,
wherein, when the specific manually captured image captured continuously exists in the memory and the preview meets a predetermined condition, the controller captures a moving picture for the preview.

16. The mobile terminal of claim 1,
wherein the controller performs the automatic image capture when at least one of the following conditions is met:
a specific event is included in the preview,
a movement of the terminal is a predetermined specific motion,
a predetermined gesture input is received on the preview,
an alarm for recommending an automatic image capture is selected, or
a specific event is received at the mobile terminal.

17. A method of controlling a mobile terminal, comprising
displaying a preview on a display unit upon activation of a camera;
determining whether the preview meets a predetermined condition; and
performing at least one automatic image capture for the preview, when the preview meets the predetermined condition.
